(19) United States
(12) Patent Application Publication
(10) Pub. No.: US 2002/0146980 A1
(43) Pub. Date: Oct. 10, 2002

(54) Wireless architecture using multiple air interface

(76) Inventors: Max Aaron Solondz, Morris Township, NJ (US); Krishnamurthy Sreenath, Township of Randolph, NJ (US)

Correspondence Address: John A. Ligon, Esq., Law Office of John Ligon, 505 Highland Avenue, P.O. Bix 43485, Upper Montclair, NJ, 07043-0485, US

(21) Appl. No.: 09/826,321

(22) Filed: Apr. 4, 2001

(51) Int. Cl. H04B 7/14

(52) U.S. Cl. 455/21; 455/15; 455/7; 455/561

(57) ABSTRACT

A wireless architecture is disclosed based on the use of two separate air interfaces on two separate sets of uplinks and downlinks. In particular, the multiple air interface architecture of the invention incorporates a re-radiator that employs two different air interface protocols. One air interface protocol is used for “backhaul” reception and transmission to the serving network base station, and is deployed between the fixed network base station and the re-radiator. This air interface protocol is optimized for transmission over a long distance and for sharing among multiple users. A second air interface protocol is used for local re-radiation between the re-radiator and a served end user device. This second air interface is optimized for very short distances. The reradiator itself is placed at a fixed location allowing it to take advantage of antenna directionality and antenna gain, and also to meet certain requirements regarding fixed terminals.

### FIELD OF INVENTION

The invention relates to wireless communications systems, and more particularly to an improved architecture for communications between a end user device and a fixed network station in such a wireless system.

### BACKGROUND OF THE INVENTION

Conventional wireless communication networks employ a single, bidirectional air interface protocol for communication between a fixed network base station and a population of served mobile stations that may be designed for either voice or data applications. For voice applications, particularly PCS, PCN and cellular systems, the mobile station is commonly implemented as a handset device, such as illustrated in FIG. 1. The constraints on the mobile terminal require it to be lightweight, battery powered, small and compact, and to employ an omnidirectional antenna because the pointing angle to the serving base station is unknown. The interface between the base station and the mobile station may have certain asymmetries due to different uplink and downlink data rates or scheduling requirements, as well as asymmetries due to different types of uplink and downlink modulation, diversity processing and/or coding schemes. Additionally, two way diversity is either deployed on the uplink base station receiver only, or on both the uplink base station receiver and on the downlink base station transmitter, so that the mobile station can use a lower powered transmitter (i.e., lower powered than the base station), and so that the mobile terminal only requires one single antenna, RF transmitter and RF receiver.

In another wireless art, where mobility of the subscriber/terminal station is not required, conventional point-to-point and point-to-multipoint systems for satellite, MDS, MMDS, or outdoor Wireless Area Network applications often employ a fixed, mounted, outdoor antenna/transceiver at the subscriber/terminal location to avoid “in-building” penetration losses and to take advantage of higher antenna directionality and antenna gain that a larger antenna provides. In these applications, the antenna height may also be increased in order to get a “line-of-sight” connection path to the serving base station. An illustrative configuration for this genre of applications is shown in FIG. 2. As with the wireless mobile applications, these applications employ a single air interface, which may be asymmetric in terms of link budget, coding, data rate, power level, or antenna gain.

With such “fixed” wireless applications, the receiver/transceiver need not be as small, lightweight, low powered, or battery powered as would be the hand held terminals of a wireless-mobile system. In these fixed wireless systems, the receiver/transmitter at the subscriber location is then connected to an end user device for the ultimate subscriber interface. That end user device may be a voice telephone system, a network based computer data system, or a television based system. Connections between the subscriber receiver/transceiver and the end user device may be via wires, cables, coax cables, or fiber optic cables. Accordingly, the end user device in this system is tethered, and therefore is not portable. Another disadvantage of this type of system is the cost burden of installation. One element of this added cost burden derives from the need for an externally mounted antenna, which also requires an outdoor, weatherproof enclosure capable of operating over an extended temperature range, along with trained technical manpower to provide the installation on the roof or wall at the subscriber location, and a right (which may have to be purchased or leased) to mount the antenna externally. Another added cost element is the need for internally routed cables to get the final signal from the antenna/receiver/transceiver to the end user device, which generally requires skilled tradespeople and will often be quite labor-intensive.

In summary, prior-art RF based PCN, PCS, cellular, WLAN and broadcast systems are characterized by a single (simplex) transmission frequency, or a frequency duplexed (FDD) set of two frequencies (duplex uplink and downlink), and a single air interface. These limitations, as well as installation cost burdens, materially reduce the utility and convenience of communications via such systems.

### SUMMARY OF THE INVENTION

Accordingly, it is an object of the invention to provide a wireless network architecture that encompasses the features of indoor portability, absence of wires or cables to the end user device, a very small, low power, low profile RF link for the end user device and an uncomplicated installation, while at the same time taking advantage of directional antenna gain and antenna mounting height to avoid difficulties associated with building penetration link budget losses. To that end, a new wireless architecture is disclosed based on the use of two separate air interfaces on two separate sets of uplinks and downlinks.

The invention allows a portable wireless device to operate within an indoor environment while employing very low power transmitter and very compact antennas by the use of an “in-home,” “in-vehicle,” or “in-office” re-radiator. The re-radiator itself is not mobile (i.e., it is placed at a fixed location), allowing it to take advantage of antenna directionality and antenna gain, and also to meet certain requirements regarding fixed terminals. The re-radiator employs two different air interface protocols. One air interface protocol is used for “backhaul” reception from and transmission to the serving service-provider network connected base station, and is deployed between the fixed network base station and the fixed “re-radiator.” This air interface protocol is optimized for transmission over long distances (on the order of 1 to 10 kilometers) and for sharing among multiple users. A second air interface protocol is used for local “re-radiation” between the “re-radiator” and the end user device. This second air interface is optimized for very short distances, on the order of 2-50 meters. The end user device may be a personal computer with a wireless LAN card, a laptop computer with a PCMCIA based wireless LAN card, a hand held computing device with a wireless LAN or infrared capability, or a wireless telephone handset type device for voice communications.

The Wireless Network Architecture of the invention allows the end user device to appear wireless and portable within the home, vehicle or office environment while the backhaul connection to the network takes advantage of the fixed antenna installation of the re-radiator. No wires or cables are required to connect the re-radiator to the end user device. And, the end user device does not require a large antenna structure or a high power transmitter to overcome in-building penetration losses or other link budget losses associated with a long distance radio link.

### BRIEF DESCRIPTION OF THE FIGURES

FIG. 1 provides a schematic depiction of a conventional bidirectional wireless architecture.

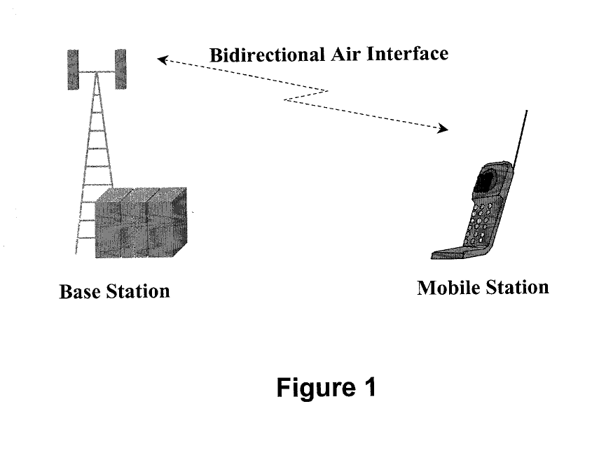

FIG. 2 provides a schematic depiction of a conventional point-to-point or point-to-multipoint wireless architecture.

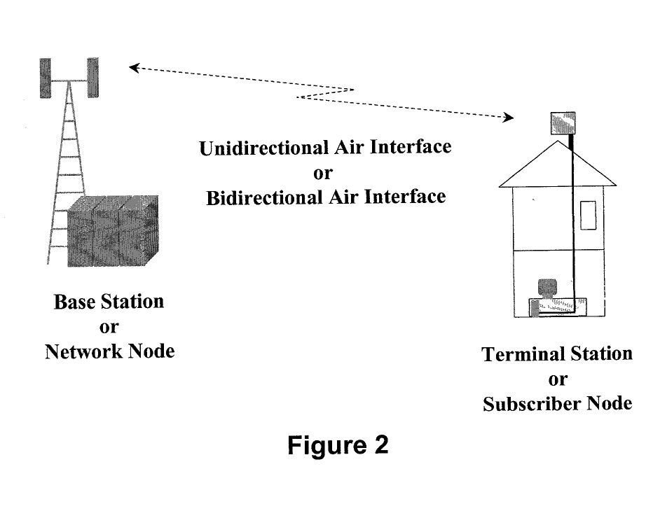

FIG. 3 provides a high-level block diagram for a conventional bi-directional wireless voice or data network.

FIG. 4 provides a high-level depiction of the multiple air interface architecture of the invention.

FIG. 5 depicts the multiple air interface architecture of the invention in functional schematic form.

FIG. 6 provides a high-level depiction of a particular application of the multiple air interface architecture of the invention.

FIG. 7 provides a high-level depiction of an alternative application of the multiple air interface architecture of the invention.

FIG. 8 shows an application of the multiple air interface architecture of the invention using antenna diversity.

### DETAILED DESCRIPTION

With the success of PCS and cellular wireless voice communications applications has come an increasing demand for wireless access to communications networks for non-voice applications, such as internet and e-mail access for laptops and PDAs. With this broadening of the universe of wireless applications, the concept of a wireless “appliance” has evolved to cover a wide variety of actual and potential devices that operate to provide a wireless interface for a given user application.

One of the characteristics of this new genre of wireless appliance is that the operating environment is more likely to be inside a building (or vehicle) than outside. However, with the wireless architecture of the existing art, there is a substantial added RF burden for transmission to or from a wireless terminal located inside such a structure, as compared to an out-of-doors terminal location. This often results in degraded performance for such an in-building terminal. A new wireless architecture is described herein to overcome this limitation.

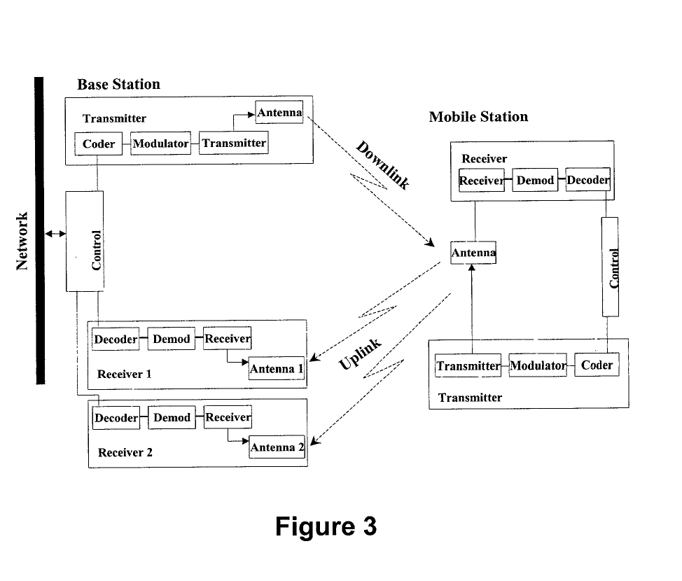

A high-level block diagram for a conventional bi-directional voice or data wireless network, such as PCS, PCN or cellular, is shown in FIG. 3. The base station of the wireless system is connected directly to the network and the mobile station interfaces directly with the base station on both the uplink and the downlink. The air interface between the mobile and the base station may be TDMA or CDMA based. Also, one or both links may deploy one, two or multiple paths of receiver diversity, and/or one or more paths of transmit diversity.

As can be seen, the conventional wireless architecture uses a single air interface for providing a wireless transmission link (uplink and downlink) between a base station and a mobile terminal, or appliance. With this conventional, single-air-interface architecture, the terminal is considered an all-in-one appliance—it incorporates both the user interface functions (e.g., voice transduction and translation/encoding) and the RF transmission equipment for the mobile terminal—and that RF transmission equipment must be capable of establishing a communications path back to the base station. In particular, the end user appliance (i.e. the mobile terminal) in the single-air-interface architecture must be able to support all the requirements for the air interface, including the need for antenna diversity, relatively high mobile transmit power, omnidirectional antenna coverage, and portability via the use of a battery. While these requirements can be met for outdoor operation with a battery-powered mobile that is lightweight and portable, the need to overcome building penetration losses makes such a device less than ideal for indoor operation.

One way of overcoming the problem of getting RF signals reliably to and from an in-building location is to put a directional antenna outside the building pointed back at the base station, which provides a much better signal. But this then creates a new problem of accommodating the user's expectation of portability for the user-interface device. As already noted, the closest prior art for such a fixed directional antenna arrangement at the user's location relies on cabling to connect the end user device to the fixed RF transceiver/antenna. Not only does the tethering of the end user device to that cabling completely defeat the idea of portability for the device, such in-building cabling is also very costly to install. A wireless system incorporating a multiple-air-interface architecture according to the invention overcomes these limitations.

The multiple air interface architecture of the invention represents a totally new network concept—a wireless network with two interfaces instead of one and three RF elements instead of two. The intermediate RF element provides the necessary modulation/demodulation/translation functions, as well as RF functions, for translation of signals between the first air interface and the second air interface. That intermediate RE element is denoted herein as a “re-radiator.” The first air interface governs transmission of the signal between an antenna of the re-radiator and the serving base station for the wireless communications network. That first air interface may encompass cellular, PCS or any other wireless transmission regime suitable to the bandwidth and transmission requirements of the transmission link between the base station and the re-radiator. Preferably, the antenna for the re-radiator will be directional, and will be positioned at a fixed location either at a window or on outside surface of the building in which the end user is situated.

The second air interface governs transmission of the signal between the reradiator and the end-user device, or appliance. Preferably, the second air interface is based on a low-power, short-range RF system, which will enhance the portability of the user interface device by minimizing the RF power components and their power requirements (and thus a smaller battery) in the user interface device. Exemplary protocols for such short-range RF systems include Bluetooth, IEEE 802.11b and HomeRF. Since all of these “local” wireless protocols are well known to those skilled in the art, no further discussion of the protocols is believed warranted. It is noted, however, that the Bluetooth protocol generally supports a shorter-distance communications link than that of 802.11b or HomeRF, and that Bluetooth devices are expected to have a considerably lower cost than devices implementing the other protocols. For that reason, the second air interface will generally be described herein in terms of the Bluetooth protocol, but it should be understood that the invention contemplates the use of any “local” RF or infrared-based protocol for the second air interface.

It can thus be seen that the inventors have addressed and solved a problem of prior-art wireless systems—i.e., attainment of suitable transmission/reception characteristics in an in-building environment, while maintaining convenient portability for the end-user device. That solution is a dual air interface for the total transmission path between an end-user device and a serving base station, with a re-radiator device at the junction of the two air interfaces. The first air interface is optimized for the relatively long-distance transmission path between the base station and the re-radiator, and the second air interface is optimized for very short distance transmission—i.e., low power RF along with a small battery and antenna.

Thus, conceptually, the invention breaks the appliance into two pieces—the user interface device and the in-building, home repeater device that handles the RF for the communications path back to the base station. The user is accordingly freed from a need to carry around the RF portion of the terminal, including a sizable and weighty battery, as well as the larger antenna (or antennas) required for directivity back to the serving base station (and for diversity). The in-building transmission link is not meant to be very robust against RF interference, but the user interface device is intended to be very low cost and very convenient for the user. The re-radiator, with which the end-user device communicates, then takes on the burden of maintaining the longer distance transmission, including the need to deal with the protocols of allowing multiple users into the system, at the same time.

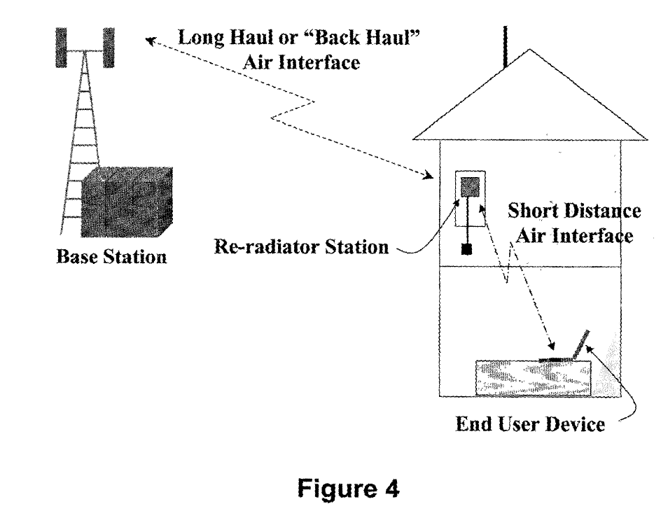

FIG. 4 provides a high-level illustration of the multiple air interface architecture of the invention. As can be seen, there are inherently three distinct station elements within a wireless network implemented according to that architecture.

a base station element that is connected to the primary backbone network of the service provider that connects to a switch based telephone system and/or a packet based data network,

a re-radiator station element that acts as a protocol converter and which has two portions for uplink (a receiver and a transmitter) and two portions for the downlink (a transmitter and a receiver), and,

an end user device, which is similar to a mobile station.

This new intermediate element, the re-radiator, plays a crucial role in enabling the air interface to be practical at higher frequencies and at longer ranges from the base station by avoiding the building penetration variability due to different locations of the end user device within the building, and by allowing the use of a larger, fixed, directional, high gain antenna.

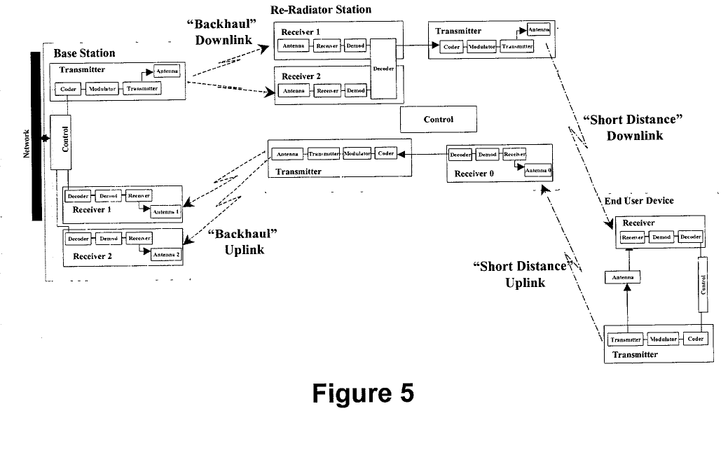

A functional schematic of the multiple-air-interface wireless architecture of the invention is shown in FIG. 5. As can be seen in the figure, the base station of the wireless architecture of the invention is similar to that of the conventional wireless system shown in FIG. 3. And, the End User Device of the wireless architecture of the invention is functionally similar to the mobile station of the conventional wireless system. The Re-radiator Station of the invention, shown in FIG. 5 as an intermediate RF element between the base station and the End-User Device, is, however, a completely new element and enables the key functionality of the multiple-air-interface wireless architecture of the invention.

Functionally, the Re-radiator Station operates as a protocol converter between the two RF air interfaces. For downlink transmissions (from the base station to the End-User Device) it translates the “Backhaul” signal from the backhaul (first) air interface to the “Short Distance” (second) air interface for local retransmission to the End-User Device. Similarly, for uplink transmissions, short distance transmissions from the End-User Device are received (via the second air interface) by the Re-Radiator Station, protocol converted, and retransmitted on the backhaul uplink (via the first air interface) back to the base station.

The Re-radiator may also encompass other transmission and administrative functions, such as access control, encryption, security and collection of billing information. In addition, with the introduction of the Re-radiator station, control and management software associated with a mobile station in a prior-art wireless system will now be partitioned between the Re-radiator station and the end user device, along with the addition of new software elements unique to the end-user device and its interface with the Re-radiator station.

In an illustrative embodiment, the translation at the Re-Radiator Station is constituted as a full demodulation/re-modulation of the signal being translated—i.e., the incoming signal to the Re-Radiator is brought from an RF interface all the way down to the digital bits of the original signal, and is then reformatted, recoded and re-modulated to the outgoing air interface.

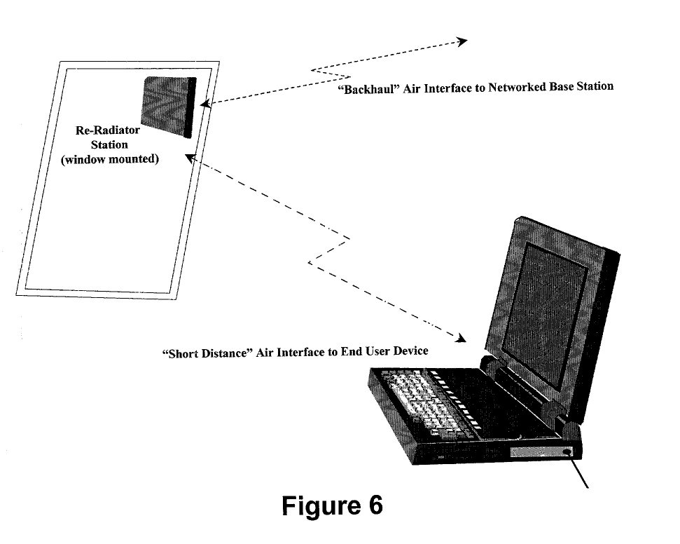

FIG. 6 provides a high-level illustration of a specific application of the multiple air interface architecture of the invention. In the illustrated application, the backhaul air interface may be HDR CDMA which is optimized for multiple simultaneous users. Illustratively, the application frequency may be at 2.3 GHz, where high gain directional antennas can be fabricated in relatively small sizes. The directional antenna for the Re-Radiator may be mounted inside the building premises, but mounted on a window, facing outward. This allows the Re-Radiator package to be manufactured relatively inexpensively, Since the operational temperature range and weather proofing requirements are not as stringent as would be required for an outdoor mounted antenna and enclosure.

Being fixed in location, the Re-Radiator unit may be powered from the building's AC power, rather than needing to be battery powered. Because the antenna is fixed and directional, it can be pointed towards the base station of interest, and thereby provide much higher gain than would be obtained from a low gain omni-directional antenna such as would be deployed with a device requiring portability. Additionally, window mounting of the Re-Radiator antenna eliminates the performance robbing effects of building penetration losses that severely hamper long-range RF link budgets. Of course, the antenna of the re-radiator could also be mounted remotely on the roof of the building where the advantages, such as additional gain, offset the convenience and lesser installation and maintenance cost of a window mounted antenna.

The Re-Radiator Station of FIG. 6 takes the illustrative bi-directional CDMA HDR data stream and converts it to the short distance protocol, which may be an IEEE 802.11b interface, operating in a different frequency band. A low frequency, such as the 46-49 MHz ISM band, may be deployed for its non-directional characteristics and its immunity to small distance fading effects. The end user device may be a laptop personal computer equipped with a PCMCIA card based 802.11b wireless local area interface. The low power and small size needed for the RF components of the short-distance, second air interface permits such a plug-in card for the laptop computer following industry standards.

Thus the end user device can still deploy the standard elements of the laptop computer, without stressing its form factor for large panel antennas, large spacing for two-way diversity, or requiring a larger battery for high-powered RF transmissions. Yet the user still perceives the device to be wireless, and may move about the interior of the building without regard for adequate signal reception, because the Re-Radiator is local.

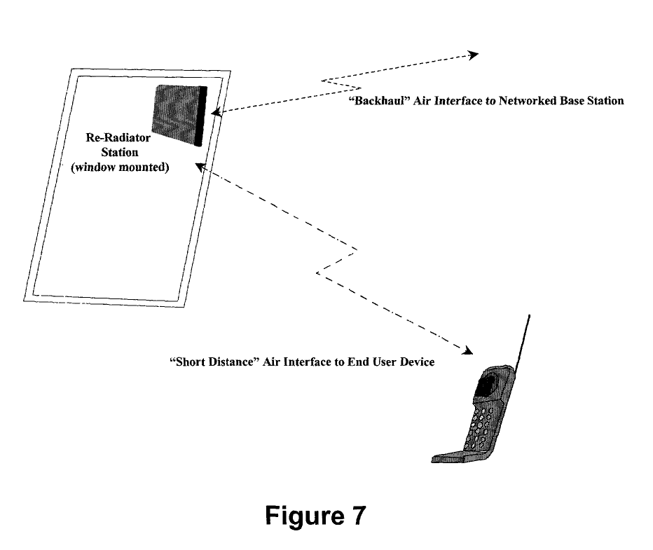

An alternative application of the multiple air interface architecture of the invention, where the end user device is in the form or a wireless phone handset, is shown in FIG. 7. Here, all of the benefits of a cordless phone are achieved without requiring a wired local loop. The handset can be quite inexpensive, as it will not require the sophisticated processing, large transmitter size, or diversity that would be necessary for a conventional cellular, PCS, or PCN phone. In similar manner, the end user device may take the form of a hand-based personal digital assistant device (e.g., a Palm based computer), a compressed video monitor (where, for example, the data stream comprises digitally compressed moving images transmitted to a viewer or recorder device), or a personal or home based audio system (the data stream typically being digitally compressed audio signals transmitted to a speaker system or a recorder). And, as with the application illustrated in FIG. 6, the interface between the end-user device and the network may be ATM, switched, or packet based.

A particular advantage of the multiple air interface architecture of the invention is that the appliance does not need to be dual-mode, tri-mode or quad-mode, as is common with prior-art wireless terminals. As is well known, such multi-mode terminals inherently require more complex RF systems in the terminal and may also impose increased power requirements resulting in larger and heavier batteries. With the invention, the appliance only has one mode, and the re-radiator carries out the function of converting that local transmission mode (e.g., Bluetooth) to the proper network air interface.

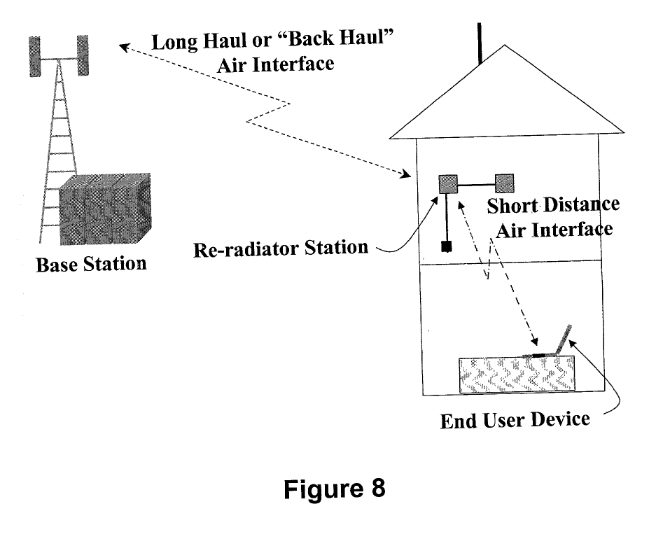

FIG. 8 provides a functional illustration of another advantage of separating the backhaul and short distance air interfaces according to the method of the invention. Diversity reception and transmission on the backhaul air interface may still be accomplished by installing two separate re-radiator station antennas a moderate distance apart from one another to employ receiver and/or transmit diversity on the backhaul air interface, or for both the backhaul and short distance air interfaces. Again, the end user device is not burdened by the size of these antennas or the need for more than one antenna. Likewise, higher-powered transmitters can be used on the backhaul air interface because the re-radiator need not be battery powered as is the end user devise. Also, higher effective radiated powered may be achieved and used because the antenna is more directional, and the antenna can be mounted in such a way as to minimize the exposure to the user.

In a particular embodiment of the invention, a number of end-user devices can be configured for a common “local” air interface (using, for example, Bluetooth), so that all will “talk” to the same re-radiator, with the re-radiator having a much more extensive air interface that will talk back to a network. For example, a laptop computer, a PDA and one or more telephone handsets used in a re-radiator equipped building can be configured with a Bluetooth protocol capability in order to establish a short distance communications link with the re-radiator. The application signal output of each such user device will be digital bits and the Bluetooth-modulated RF signal will be demodulated at the re-radiator to recover the application signal prior to remodulating that signal for transmission to a network base station via a selected backhaul air interface. Thus the light-weight portability of each user device is maintained while providing a seamless connection between the device and a landline network that will provide a connection to the ultimate source/sink with which the device is communicating.

Another embodiment of the invention involves the use of different re-radiators in different modes with the same end-user appliances. For example, one could use a given user device—e.g. a PDA enabled with the short-range wireless protocol—to communicate with an office network (and ultimately with external networks) via a wireless LAN port at the office. The same user device could also be used at the user's home to communicate with a re-radiator installed in the home, and ultimately outside networks via the wireless transmission link between the re-radiator and a serving base station.

Moreover, by installing a compatible re-radiator in the user's automobile (which would derive its power from the cars battery), the user device can also be used within or in close proximity to that automobile for access to outside networks (again via the wireless transmission link between the automobile re-radiator and a serving base station). Because the automobile is itself inherently mobile, the re-radiator will require an omnidirectional antenna, but the combined higher RF power available from the re-radiator and the expected external mounting of the automobile antenna will provide significant gain improvement over a hand-held unit required to communicate directly with the base station.

In similar manner, different types of re-radiator stations could be deployed, sharing a common short distance air protocol, but deploying different backhaul air interface protocols for different service areas and different applications (e.g., low versus high speed). Again, the functional relocation of protocol conversion, multiple diversity antennas, a substantial battery power supply and form factor antenna requirements from the end user device to the re-radiator station allows these elements to be remoted from the portable end user devices. Thus the multiple air interface architecture of the invention will enable seamless operation of the end-user device in a number of different areas and operating environments.

In summary, a key point of the invention is to optimize the air interface for what is going on in diverse segments of the total wireless transmission path, including the separation of the very short distance protocol from the long distance protocol and doing different things with them for different reasons. With the dual air interface architecture of the invention, and considering the low-cost expected to be associated with the air interface for the Bluetooth/802.11 short-distance protocol, it is expected that the end-user appliance may be made much, much smaller and much, much cheaper than conventional mobile devices—in part, because it won't have the burden of trying to maintain the CDMA/TDMA link back to the base station.

Numerous modifications and alternative embodiments of the invention will be apparent to those skilled in the art in view of the foregoing description. Accordingly, this description is to be construed as illustrative only and is for the purpose of teaching those skilled in the art the best mode of carrying out the invention and is not intended to illustrate all possible forms thereof. It is also understood that the words used are words of description, rather that limitation, and that details of the structure may be varied substantially without departing from the spirit of the invention and the exclusive use of all modifications which come within the scope of the appended claims is reserved.

1. A method for operating a wireless communications system comprising the steps of:
providing an intermediate RF element between a base station of said wireless communications system and an end user device of said system, said intermediate RF element being operative to maintain a communications link with said base station via a first air interface and with said end user device via a second air interface, and being further operative to translate a signal between said first and said second air interfaces.

2. The method of claim 1 wherein said first air interface is optimized for longer distance transmission and said second air interface is optimized for short distance transmission.

3. The method of claim 1 wherein said second air interface incorporates a Bluetooth protocol.

4. The method of claim 1 wherein said second air interface incorporates an IEEE 802.11b protocol.

5. The method of claim 1 wherein said intermediate RF element provides a protocol conversion between said first air interface and said second air interface.

6. The method of claim 1 wherein, for downlink transmission from said base station, said signal translation by said intermediate RF element encompasses a demodulation of a signal transmitted via said first air interface down to an application signal level and a re-modulation of said application signal level for transmission via said second air interface.

7. The method of claim 1 wherein, for uplink transmission from said end user device, said signal translation by said intermediate RF element encompasses a demodulation of a signal transmitted via said second air interface down to an application signal level and a re-modulation of said application signal level for transmission via said first air interface.

8. The method of claim 1 wherein a plurality of end user devices are provided a capability for communication via said second air interface with a given one of said intermediate RF elements when located proximately to said given one of said intermediate RF elements.

9. The method of claim 1 wherein ones of a plurality of said intermediate RF elements are provided at dispersed locations and further wherein all said ones of said plurality are provided a capability for communication via said second air interface with a given one of said end user devices.

10. A wireless system comprising:
a base station interconnected with a terrestrial communications network and operative to establish and maintain a wireless communications path via a first air interface;
an end user device operative to establish and maintain a wireless communications path via a second air interface; and
an intermediate RF element disposed in proximity to said end user device and operative to effect an interconnection between (1) a communications path between said intermediate RF element and said end user device via said second air interface and (2) a communications path between said intermediate RF element and said base station via said first air interface.

11. The wireless system of claim 10 wherein said first air interface is optimized for longer distance transmission and said second air interface is optimized for short distance transmission.

12. The wireless system of claim 10 wherein said second air interface incorporates a Bluetooth protocol.

13. The wireless system of claim 10 wherein said second air interface incorporates an IEEE 802.11b protocol.

14. The wireless system of claim 10 wherein said intermediate RF element provides a protocol conversion between said first air interface and said second air interface.

15. The wireless system of claim 10 wherein said intermediate RF element provides a signal translation between said first and said second air interfaces.

16. The wireless system of claim 15 wherein, for downlink transmission from said base station, said signal translation by said intermediate RF element encompasses a demodulation of a signal transmitted via said first air interface down to an application signal level and a re-modulation of said application signal level for transmission via said second air interface.

17. The wireless system of claim 15 wherein, for uplink transmission from said end user device, said signal translation by said intermediate RF element encompasses a demodulation of a signal transmitted via said second air interface down to an application signal level and a re-modulation of said application signal level for transmission via said first air interface.

18. A wireless architecture comprising:
a fixed base station operative to establish and maintain a wireless communications path via a first air interface;
an end user device operative to establish and maintain a wireless communications path via a second air interface; and
an intermediate RF element established to communicate with said base station via said first air interface and with said end user device via said second air interface and operative to translate a signal from said first air interface to said second air interface.

19. The wireless architecture of claim 18 wherein said first air interface is optimized for longer distance transmission and said second air interface is optimized for short distance transmission.

20. The wireless architecture of claim 18 wherein said intermediate RF element provides a protocol conversion between said first air interface and said second air interface.

21. The wireless architecture of claim 18 wherein said signal translation encompasses a demodulation of a signal inbound to said intermediate RF element down to an application signal level and a re-modulation of said application signal level for transmission via an outgoing air interface of said intermediate RF element.
